(19) United States
(12) Patent Application Publication
(10) Pub. No.: US 2023/0369771 A1
(43) Pub. Date: Nov. 16, 2023

(54) ANTENNA ASSEMBLY FOR ELECTRICAL DEVICE

(71) Applicants: TE Connectivity Solutions GmbH, Schaffhausen (CH); Tyco Electronics Holdings (Bermuda) VII Ltd, Taipei (TW)

(72) Inventors: Xing Yun, Oxford, MI (US); Sin-Hooi Cheah, Taipei (TW)

(21) Appl. No.: 17/740,809

(22) Filed: May 10, 2022

(51) Int. Cl. H01Q 13/18; H01Q 19/185; H01Q 9/04

(52) U.S. Cl. CPC H01Q 13/18; H01Q 19/185; H01Q 9/0414

(57) ABSTRACT

An electrical device includes a device housing having an internal cavity. The electrical device includes a device sensor in the internal cavity. The electrical device includes a control circuit board in the internal cavity. The control circuit board includes a sensor circuit coupled to the device sensor. The control circuit board includes a ground circuit and a communication circuit with a feed circuit. The electrical device includes an antenna assembly coupled to the control circuit board. The antenna assembly includes a substrate mounted to the control circuit board and an antenna element extending along at least one surface of the substrate. The antenna element is coupled to the feed circuit and the ground circuit. The antenna assembly includes a switchable matching circuit coupled to the antenna element. The switchable matching circuit changes a feed impedance of the feed circuit.

### BACKGROUND OF THE INVENTION

The subject matter herein relates generally to antenna assemblies for electrical devices.

Antennas are used in electrical devices to wirelessly communicate with other devices or a central communication unit. For example, electrical devices used within a home or building may communicate with a central monitoring system. The electrical devices may include sensors for monitoring the environment of the building or home, such as temperature, motion, door or window monitors. It is desirable for the electrical devices to be small and have a low profile. There is limited space in the electrical device for the antenna. Additionally, the electrical devices may be mounted within the home or building in different orientations and to different surfaces, such as wood, concrete, metal, drywall, or other types of building materials. In some instances, the electrical devices are mounted to a metal surface, such as a metal wall, plate, door, window, and the like. The metal surface interferes with the operation of the antenna, such as affecting the radiation pattern and/or antenna efficiency.

A need remains for an antenna assembly for an electrical device that operates efficiently even being mounted in different orientations and to different structures, including metal surfaces, wood surfaces, concrete surfaces or other materials.

### BRIEF DESCRIPTION OF THE INVENTION

In one embodiment, an electrical device is provided and includes a device housing having an internal cavity. The device housing has a front and a rear opposite the front. The device housing has a first side and a second side extending between the front and the rear. The electrical device includes a device sensor in the internal cavity. The electrical device includes a control circuit board in the internal cavity. The control circuit board includes a sensor circuit coupled to the device sensor. The control circuit board includes a ground circuit. The control circuit board includes a communication circuit has a feed circuit. The electrical device includes an antenna assembly coupled to the control circuit board. The antenna assembly includes a substrate mounted to the control circuit board and an antenna element extending along at least one surface of the substrate. The antenna element is coupled to the feed circuit and the ground circuit. The antenna assembly includes a switchable matching circuit coupled to the antenna element. The switchable matching circuit changes a feed impedance of the feed circuit.

In another embodiment, an antenna assembly for an electrical device is provided and includes a control circuit board having a feed circuit and a ground circuit. The antenna assembly for the electrical device includes a substrate mounted to the control circuit board. The substrate has a surface. The antenna assembly for the electrical device includes an antenna element extending along the surface. The antenna element is coupled to the feed circuit and the ground circuit. The antenna assembly for the electrical device includes a switchable matching circuit coupled to the antenna element. The switchable matching circuit changes a feed impedance of the feed circuit.

In a further embodiment, an electrical device is provided and includes a device housing having an internal cavity. The device housing has a front and a rear opposite the front. The device housing has a first side and a second side extending between the front and the rear. The device housing has an external surface configured to be mounted to a mounting surface of a wall. The electrical device includes a device sensor in the internal cavity. The electrical device includes a ground contact coupled to the device housing. The ground contact is configured to be electrically connected to the metal wall. The electrical device includes a control circuit board in the internal cavity. The control circuit board includes a sensor circuit coupled to the device sensor. The control circuit board includes a communication circuit having a feed circuit. The control circuit board includes a ground circuit. The ground circuit is electrically connected to the ground contact. The electrical device includes an antenna assembly coupled to the control circuit board. The antenna assembly includes a substrate mounted to the control circuit board and an antenna element extending along at least one surface of the substrate. The antenna element is coupled to the feed circuit and the ground circuit. The antenna element is electrically connected to the wall through the ground contact and the ground circuit of the control circuit board.

### BRIEF DESCRIPTION OF THE DRAWINGS

FIG. 1 is a perspective view of an electrical device including an antenna assembly (shown in phantom) in accordance with an exemplary embodiment.

FIG. 2 is a side view of the electrical device in accordance with an exemplary embodiment.

FIG. 3 is an end view of the electrical device mounted to a wall in a first mounting configuration in accordance with an exemplary embodiment.

FIG. 4 is an end view of the electrical device mounted to the wall in a second mounting configuration in accordance with an exemplary embodiment.

FIG. 5 is an end view of the electrical device mounted to the wall in a third mounting configuration in accordance with an exemplary embodiment.

FIG. 6 is a perspective view of a portion of the electrical device showing internal components of the electrical device in accordance with an exemplary embodiment.

FIG. 7 is a front view of a portion of the electrical device showing internal components of the electrical device in accordance with an exemplary embodiment.

FIG. 8 is an end view of the electrical device coupled to the wall in the third mounting configuration in accordance with an exemplary embodiment.

FIG. 9 is an exploded view of a portion of electrical device in accordance with an exemplary embodiment.

FIG. 10 is a perspective view of the antenna assembly in accordance with an exemplary embodiment.

FIG. 11 is an end view of the antenna assembly in accordance with an exemplary embodiment.

### DETAILED DESCRIPTION OF THE INVENTION

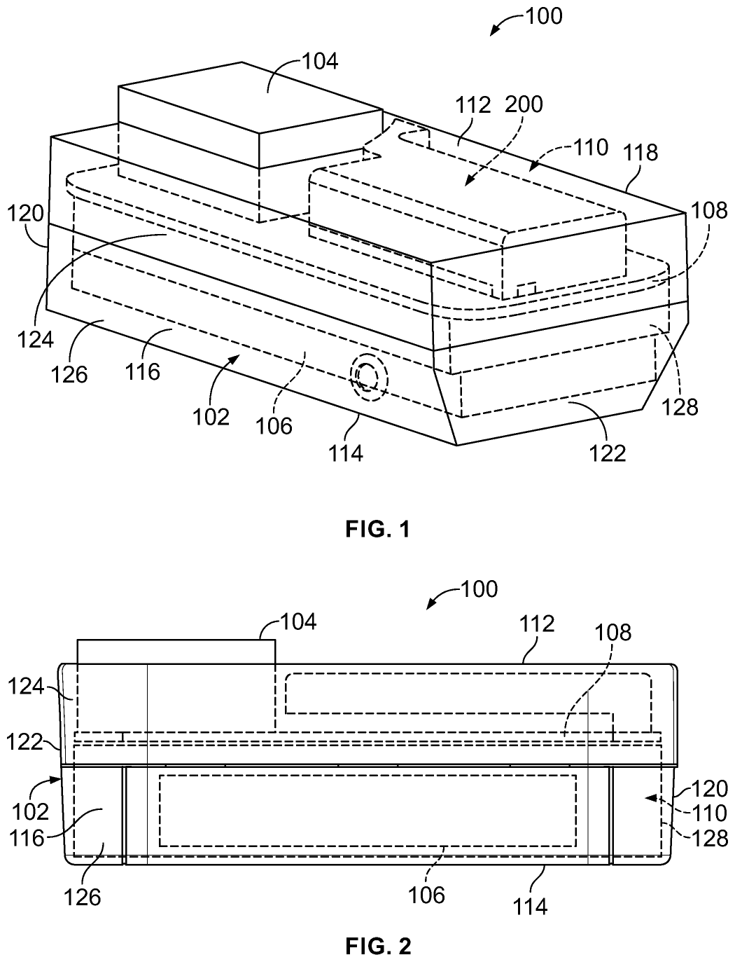

FIG. 1 is a perspective view of an electrical device 100 including an antenna assembly 200 (shown in phantom) in accordance with an exemplary embodiment. FIG. 2 is a side view of the electrical device 100 in accordance with an exemplary embodiment. The electrical device 100 includes a device housing 102 holding a device sensor 104 and the battery 106 (shown in phantom). The electrical device 100 includes a control circuit board 108 (shown in phantom).

In an exemplary embodiment, the electrical device 100 is a monitoring device used for monitoring an environment. For example, the electrical device 100 may be used in the building or home for monitoring the building or home. In various embodiments, the electrical device 100 may include a camera for imaging around the electrical device 100. In other various embodiments, the electrical device 100 may include a motion sensor for detecting motion within the building or home. In other various embodiments, the electrical device 100 may include a proximity sensor configured to monitor proximity to another device, such as for door or window opening. In other various embodiments, the electrical device 100 may include a temperature sensor. The electrical device 100 may be a gas sensor, such as a smoke sensor, or other gas sensor.

In an exemplary embodiment, the electrical device 100 is communicatively coupled to a central control system, such as a whole home monitoring system. For example, the electrical device 100 may communicate with the central control system through wireless communication. The antenna assembly 200 is used for wireless communication with the central control system.

The device housing 102 has an internal cavity 110. The device sensor 104, the battery 106, the control circuit board 108, and the antenna assembly 200 are arranged in the internal cavity 110. In various embodiments, the device sensor 104 may extend to an exterior of the device housing 102, such as for monitoring the external environment around the electrical device 100. The device sensor 104 may have any appropriate size or shape for the particular application. In the illustrated embodiment, the device sensor 104 may be rectangular. In other various embodiments, the device sensor 104 may have other shapes, such as a hemispherical shape. The device housing 102 includes a front 112 and a rear 114 opposite the front 112. The device housing 102 includes a first side 116 and a second side 118 opposite the first side 116. The first and second sides 116, 118 extend between the front 112 and the rear 114. The device housing 102 includes a first end 120 and a second end 122 opposite the first end 120. The electrical device 100 may be oriented such that the first end 120 defines a top and may be referred to hereinafter as a top 120 and the second end 122 defines a bottom and may be referred to hereinafter as a bottom 122. The device housing 102 may be generally box shaped having generally orthogonal walls defining the exterior of the device housing 102. However, the device housing 102 may have other shapes in alternative embodiments. Optionally, the walls may meet at corners. The walls may be oriented generally perpendicular to each other. Alternatively, the walls may be angled at the corners or rounded at the corners. In various embodiments, one or more of the walls may be arcuate rather than planar.

In an exemplary embodiment, the device housing 102 is a multi-piece housing. For example, the device housing 102 may include a cover 124 at the front 112 and a base 126 at the rear 114. The cover 124 is coupled to the base 126, such as using latches, fasteners, or other securing means. In various embodiments, the device housing 102 may include an insert 128 (shown in phantom) received in the base 126. The insert 128 may be separate and discrete from the cover 124 and the base 126. The insert 128 may hold various components, such as the battery 106 and/or the device sensor 104 and/or the control circuit board 108. In an exemplary embodiment, the cover 124 is latchably coupled to the insert 128 and the insert 128 is latchably coupled to the base 126. For example, the base 126 may be mounted to a mounting surface of a wall within the home or building and then the insert 128 may be inserted into the base 126 on the wall. The cover 124 may be coupled to the insert 128 prior to loading the insert 128 into the base 126. Alternatively, the cover 124 may be coupled to the insert 128 and/or the base 126 after the insert 128 is loaded into the base 126.

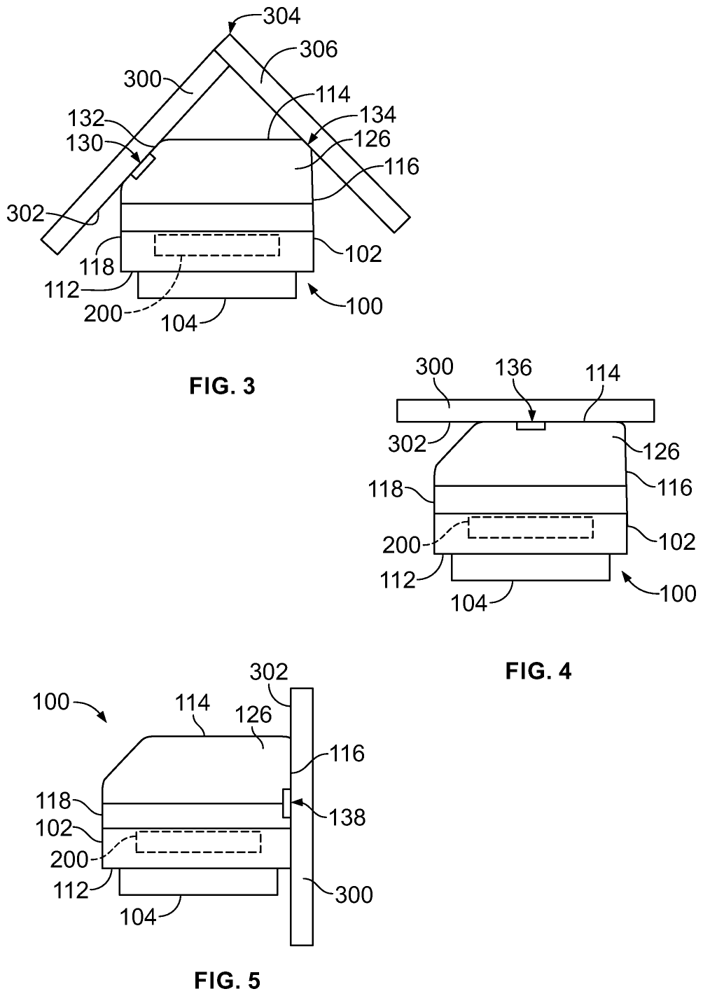

FIG. 3 is an end view of the electrical device 100 mounted to a wall 300 in a first mounting configuration. FIG. 4 is an end view of the electrical device 100 mounted to the wall 300 in a second mounting configuration. FIG. 5 is an end view of the electrical device 100 mounted to the wall 300 in a third mounting configuration. The electrical device 100 is mountable to the wall 300 in the different mounting configurations to allow placement of the electrical device 100 at an appropriate location within the home or building, such as in a corner of a room, along a wall facing outward into the room, or along a wall facing along the wall. Other mounting configurations are possible in alternative embodiments.

In an exemplary embodiment, the electrical device 100 may be mounted to different types of walls 300. For example, the electrical device 100 may be mounted to drywall hanging on a wood stud wall or a metal stud wall. The electrical device 100 may be mounted to a wood wall, such as a door frame or window frame. The electrical device 100 may be mounted to a metal wall, such as a door, a door frame, a window casing, and the like. The electrical device 100 may be mounted to a different type of material, such as concrete.

The different types of walls 300 affect the performance and operation of the antenna assembly 200. The mounting configuration on the walls 300 affect the performance and operation of the antenna assembly 200. In an exemplary embodiment, the antenna assembly 200 is robust and designed for operation when mounted to the various different types of walls and at the various mounting configurations.

The base 126 of the device housing 102 has different mounting locations for mounting in the various mounting configurations. For example, the base 126 has a first mounting location 130 at a chamfered corner 132 between the rear 114 and the second side 118. The chamfered corner 132 is a generally planar surface that allows mounting to a mounting surface 302 of the wall 300. FIG. 3 illustrates the electrical device 100 in the first mounting configuration with the first mounting location 130 coupled to the corresponding mounting surface 302 of the wall 300. The electrical device 100 may be mounted at a corner 304 between the wall 300 and a second wall 306. Optionally, a corner 134 of the device housing 102 opposite the chamfered corner 132 is configured to engage the second wall 306 to enhance stability in the first mounting configuration. The base 126 may include openings along the first mounting location 130, such as a pair of openings, that receive screws used to mount the base 126 to the wall 300. In the first mounting configuration, the device sensor 104 is located at the front 112 and faces outward into the room, such as at an angle (for example, 45°) relative to the wall 300 and the second wall 306.

The base 126 has a second mounting location 136 along the rear 114. FIG. 4 illustrates the electrical device 100 in the second mounting configuration with the second mounting location 136 coupled to the corresponding mounting surface 302 of the wall 300. The base 126 may include openings along the second mounting location 136 that receive screws used to mount the base 126 to the wall 300. In the second mounting configuration, the device sensor 104 is located at the front 112 and faces outward into the room, such as orthogonal to the wall 300.

The base 126 has a third mounting location 138 along the first side 116. FIG. 5 illustrates the electrical device 100 in the third mounting configuration with the third mounting location 138 coupled to the corresponding mounting surface 302 of the wall 300. The base 126 may include openings along the third mounting location 138 that receive screws used to mount the base 126 to the wall 300. In the third mounting configuration, the device sensor 104 is located at the front 112 and faces in a direction parallel to the wall 300.

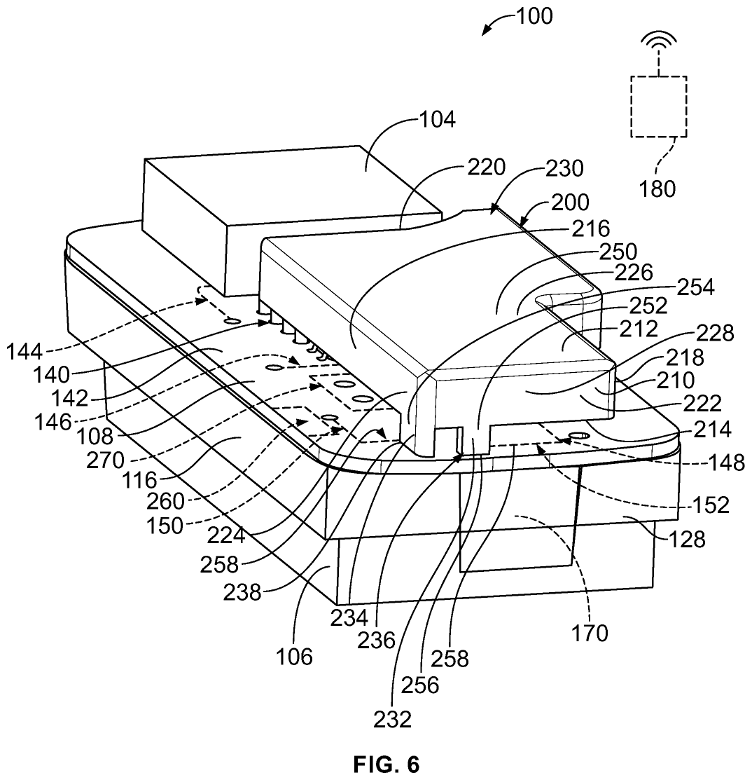

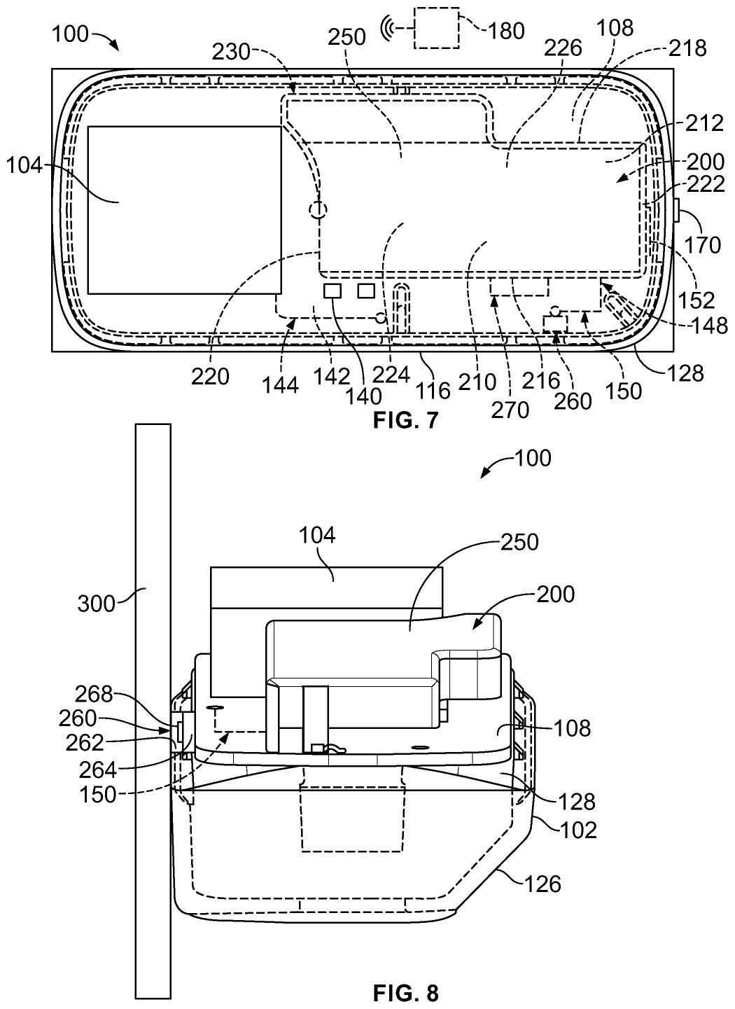

FIG. 6 is a perspective view of a portion of the electrical device 100 showing internal components of the electrical device 100. FIG. 7 is a front view of a portion of the electrical device 100 showing internal components of the electrical device 100. FIGS. 6 and 7 illustrate the control circuit board 108 and the battery 106 coupled to the insert 128. FIGS. 6 and 7 illustrate the device sensor 104 and the antenna assembly 200 coupled to the control circuit board 108. The device sensor 104 may be powered by the battery 106, such as through the control circuit board 108.

The control circuit board 108 includes circuits and circuit components 140 mounted to a surface 142 of the control circuit board 108. In an exemplary embodiment, the control circuit board 108 includes a sensor circuit 144, a power circuit 146, and a communication circuit 148. The device sensor 104 is coupled to the sensor circuit 144. The battery 106 is coupled to the power circuit 146. Optionally, the device sensor 104 is coupled to the power circuit 146 to power the device sensor 104. The antenna assembly 200 is coupled to the communication circuit 148. In an exemplary embodiment, the communication circuit 148 includes a ground circuit 150 and a feed circuit 152. The ground circuit 150 may be a ground plane along one or more layers of the control circuit board 108.

The antenna assembly 200 is mounted to the surface 142 of the control circuit board 108. Optionally, the antenna assembly 200 may be spaced apart from the surface 142 to allow room for the circuit components 140.

The antenna assembly 200 includes a substrate 210 and an antenna element 250 on the substrate 210. In an exemplary embodiment, the substrate 210 is a separate component dedicated to the antenna assembly 200 and mounted to the control circuit board 108. However, in alternative embodiments, the substrate 210 may be another component of the electrical device 100, such as the cover 124 (shown in FIG. 1), that serves another function for the electrical device 100 in addition to being the substrate for the antenna assembly 200.

In an exemplary embodiment, the antenna element 250 is formed on the substrate 210. The antenna element 250 may be manufactured by laser direct structuring (LDS) the antenna element 250 on the substrate 210. For example, the substrate 210 may be manufactured from a plastic material that is a carrier for metal particles which are formed into a circuit on the surface of the substrate 210 using a laser. The circuit may be plated to enhance the circuit on the surface of the substrate 210. The antenna element 250 takes the shape of the substrate 210 in the areas where the antenna element 250 is formed. Optionally, the antenna element 250 may substantially or entirely cover the surface of the substrate 210. The antenna element 250 may be a meandering or serpentine circuit element on the substrate 210. In various embodiments the antenna element 250 is a meandering planar inverted-F antenna (PIFA). The length of the meandering structure may correspond to ¼ wavelength of the operating frequency of the wireless device. The antenna element 250 may be formed by other processes in alternative embodiments, such as circuit board manufacturing processes. In other embodiments, the antenna element 250 may be a separate component coupled to the substrate 210. For example, the antenna element 250 may be a flexible circuit coupled to the substrate 210.

The antenna element 250 includes a feed element 252 and a ground element 254. The feed element 252 is configured to be coupled to the feed circuit 152 of the control circuit board 108. The ground element 254 is configured to be coupled to the ground circuit 150 of the control circuit board 108. The antenna element 250 may cover one or more surfaces of the substrate 210.

The substrate 210 includes a front 212 and a rear 214 opposite the front 212. The substrate 210 includes a first side 216 and a second side 218 opposite the first side 216. The first and second sides 216, 218 extend between the front 212 and the rear 214. The substrate 210 includes a first end 220 and a second end 222 opposite the first end 220. The substrate 210 may be oriented such that the first end 220 defines a top and may be referred to hereinafter as a top 220 and the second end 222 defines a bottom and may be referred to hereinafter as a bottom 222. The bottom 222 of the substrate 210 may be elevated slightly above the control circuit board 108, such as to allow SMT components on the control circuit board 108. The substrate 210 may be generally box-shaped having generally orthogonal walls defining an exterior surface 224 of the substrate 210. For example, the substrate 210 may include an outer wall 226, such as at the front 212, and sidewalls 228 extending from the outer wall 226, such as along the sides 216, 218 and the ends 220, 222. However, the substrate 210 may have other shapes in alternative embodiments. The antenna element 250 may be formed on the exterior surface 224, such as along the outer wall 226 and/or the sidewalls 228. The substrate 210 includes an interior opposite the outer wall 226. The interior faces the control circuit board 108. The antenna element 250 may be formed on the interior.

In an exemplary embodiment, the substrate 210 includes an extension 230 along the second side 218. In the illustrated embodiment, the extension 230 is located at the first end 220. The extension 230 may extend beyond the first end 220, such as along the device sensor 104. The extension 230 increases a surface area of the substrate 210 for the antenna element 250. In an exemplary embodiment, the extension 230 is located remote from the feed element 252 and the ground element 254. The extension 230 provides an area of increased antenna length for the antenna element 250, being located opposite the feed element 252 and the ground element 254. The extension 230 may be located remote from the third mounting location 138 (first side 116) to locate the antenna element 250 remote from the wall (for example, the metal wall) when the electrical device 100 is in the third mounting configuration.

In an exemplary embodiment, the substrate 210 includes a first support leg 232 and a second support leg 234. The support legs 232, 234 are coupled to the control circuit board 108. The support legs 232, 234 support the substrate 210 at an elevated position relative to the control circuit board 108. The support legs 232, 234 may be press-fit into the control circuit board 108. Optionally, the support legs 232, 234 may include latches or clips configured to be secured to the control circuit board 108. In an exemplary embodiment, the feed element 252 extends along the first support leg 232 and the ground element 254 extends along the second support leg 234. The feed element 252 extends along the first support leg 232 to connect to the feed circuit 152. In an exemplary embodiment, the feed element 252 includes a feed point 256 coupled to the feed circuit 152. In various embodiments, the feed element 252 extends into a via in the control circuit board 108 and may be soldered to the control circuit board 108. The ground element 254 extends along the second support leg 234 to connect to the ground circuit 150. In various embodiments, the ground element 254 extends into a via in the control circuit board 108 and may be soldered to the control circuit board 108.

In alternative embodiments, the feed element 252 may be electrically connected to the feed circuit 152 by a feed contact 236, such as a spring finger contact. The ground element 254 may be electrically connected to the ground circuit 150 by a ground contact 238, such as a spring finger contact. In various embodiments, the contacts 236, 238 may be soldered to the feed element 252 and ground element 254, respectively. The contacts 236, 238 may be connected to the feed element 252 and ground element 254, respectively, at separable interfaces, such as by spring fingers. The contacts 236, 238 may be soldered to the feed circuit 152 and ground circuit 150, respectively. The contacts 236, 238 may be connected to the feed circuit 152 and ground circuit 150, respectively, at separable interfaces, such as by spring fingers 258. The spring fingers 258 of the feed contact 236 is spring biased against the feed circuit 152 to electrically connect the antenna element 250 to the feed circuit 152.

Antenna signals are transmitted along the communication circuit 148, such as along the feed circuit 152, to feed the antenna element 250. The antenna element 250 allows wireless communication between the electrical device 100 and a remote device, such as the home monitoring system. In various embodiments the antenna element 250 is a meandering planar inverted-F antenna (PIFA). The length of the meandering structure may correspond to ¼ wavelength of the operating frequency of the wireless device. In an exemplary embodiment, the antenna element 250 is sized and shaped for proper operation in the various mounting orientations and for proper operation when mounted to the different wall types (for example, metal vs. non-metal). In an exemplary embodiment, the antenna assembly 200 includes enhancing circuits to enhance performance of the antenna assembly 200, such as when mounted to a metal wall, because the metal wall affects the antenna characteristics more than a non-metal wall. For example, the metal wall may affect the return loss of the antenna. The metal wall may affect the radiation pattern of the antenna. The enhancing circuits improve the operation of the antenna assembly 200 by lowering return loss. The enhancing circuits improve the operation of the antenna assembly 200 by reducing the non-radiative nearfield to increase the effective radiation efficiency.

In an exemplary embodiment, the enhancing circuits of the antenna assembly 200 includes a grounding circuit 260 and a switchable matching circuit 270 coupled to the antenna element 250. The grounding circuit 260 is configured to be electrically grounded to another structure, such as to the metal wall 300 when the electrical device 100 is mounted to the metal wall 300. The grounding circuit 260 may use the mounting screws used to mount the electrical device 100 to the metal wall 300 to electrically connect the grounding circuit 260 to the metal wall 300.

The switchable matching circuit 270 may be included as part of the control circuit board 108 and operably coupled to the feed circuit 152. For example, the switchable matching circuit 270 may be one of the circuit components 140 of the control circuit board 108. The switchable matching circuit 270 changes a feed impedance of the feed circuit 152. In an exemplary embodiment, the switchable matching circuit 270 includes lump elements, such as capacitors, inductors, and the like, having different capacitance values configured to be switchably coupled to the antenna element 250 to change the feed impedance to the antenna element 250. The switchable matching circuit 270 includes a switch to change the feed input to the antenna element 250.

In an exemplary embodiment, the switchable matching circuit 270 is operated in a first state when the electrical device 100 is mounted to a metal wall and the switchable matching circuit 270 is operated in a second state when the electrical device 100 is mounted to a non-metal wall, such as a wood wall, drywall, concrete, or other non-metal wall. The switchable matching circuit 270 has a first feed impedance when operated in the first state and the switchable matching circuit 270 has a second feed impedance when operated in the second state.

In an exemplary embodiment, the switchable matching circuit 270 is automatically switched to change the operating state of the switchable matching circuit 270. The switchable matching circuit 270 may be automatically switched based on measured efficiency of operation of the antenna assembly. For example, if the efficiency of the antenna operation is below a threshold or in a particular range, then the switchable matching circuit 270 may be automatically switched. In various embodiments, when the electrical device 100 is mounted to a wood wall, the efficiency may be at in an appropriate operation range. However, when the electrical device 100 is mounted to a metal wall, the efficiency may be reduced, such as below a threshold or to a particular range, and the antenna assembly 200 may activate the switchable matching circuit 270 to improve the antenna operation. The switchable matching circuit 270 improves the operation of the antenna assembly 200 by lowering return loss. In various embodiments, the antenna assembly 200 may include a feedback loop to monitor operation and performance of the antenna assembly 200 during use and the antenna assembly 200 may be controlled based on input from the feedback loop.

In an exemplary embodiment, the electrical device 100 may include a mechanical switch 170 (schematically illustrated in FIGS. 6 and 7). The mechanical switch 170 may be slide, lever, knob, button, or other type of switch. The mechanical switch 170 may be manipulated by the installer or homeowner, such as by pressing, pushing, turning, or otherwise physically operating the mechanical switch 170, to change the state of the switchable matching circuit 270. The mechanical switch 170 may be coupled to the device housing. The mechanical switch 170 is operably coupled to the switchable matching circuit 270. The state of the switchable matching circuit 270 is changed based on movement of the mechanical switch 170. For example, when the electrical device 100 is installed on a metal wall, the installer or homeowner may manually move the mechanical switch 170 to change the state of the switchable matching circuit 270.

In an exemplary embodiment, the antenna assembly 200 is communicatively coupled to a remote control unit 180. The antenna element 250 is configured to receive control signals from the remote control unit 180. The switchable matching circuit 270 may be operated based on the control signal. The remote control unit 180 may be a whole home monitoring system having a central control panel. The installer or homeowner may control the operating state of the switchable matching circuit 270 from the central control panel. In other embodiments, the remote control unit 180 may be a handheld device, such as a mobile phone, a computer, or a remote controller dedicated to control of the whole home monitoring system. The user may control the switchable matching circuit 270 from the handheld device. For example, when the electrical device 100 is installed on a metal wall, the installer or homeowner may send a control signal to the electrical device 100 to change the state of the switchable matching circuit 270.

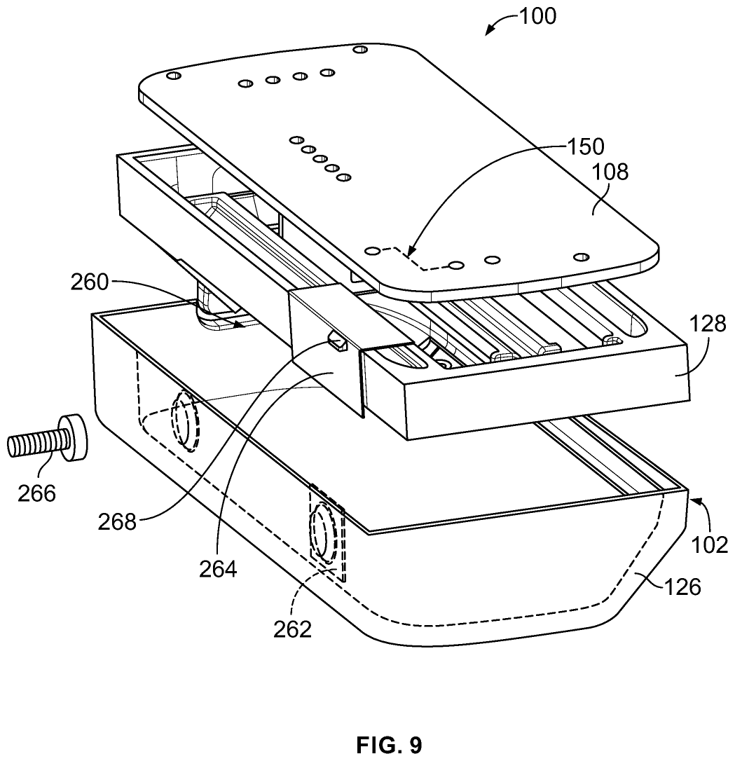

FIG. 8 is an end view of the electrical device 100 coupled to the wall 300 in the third mounting configuration. FIG. 9 is an exploded view of a portion of electrical device 100 in accordance with an exemplary embodiment. The wall 300 is a metal wall. FIGS. 8 and 9 illustrate the grounding circuit 260 used to electrically ground the antenna assembly 200 to the metal wall 300.

In an exemplary embodiment, the electrical device 100 includes at least one ground contact configured to be electrically connected to the wall 300. In the illustrated embodiment, the electrical device 100 includes a first ground contact 262 and a second ground contact 264. The first ground contact 262 is coupled to the base 126. The second ground contact 264 is coupled to the insert 128. The first ground contact 262 is coupled to the second ground contact 264. In an exemplary embodiment, the electrical device 100 includes mounting screws 266 used to mount the device housing 102 to the wall 300. For example, the mounting screws 266 may be coupled to the base 126 to secure the base 126 to the wall 300. The mounting screw 266 may be threadably coupled to the wall 300 to electrically connect to the wall 300. The mounting screw 266 is electrically conductive. In an exemplary embodiment, the mounting screw 266 is electrically connected to the first ground contact 262 and configured to be electrically connected to the metal wall 300. The second ground contact 264 is connected to the first ground contact 262 by a connecting tab 268. In the illustrated embodiment, the connecting tab 268 is integral with the second ground contact 262. The connecting tab 268 is a deflectable tab configured to engage and bias against the first ground contact 262. In various embodiments, the connecting tab 268 is integral with the first ground contact 262 or the second ground contact 264.

The ground circuit 150 is configured to be electrically connected to the second ground contact 264. In an exemplary embodiment, the control circuit board 108 is coupled to the second ground contact 264. For example, a portion of the second ground contact 264 extends into the insert 128. The control circuit board 108 engages the second ground contact 264 to electrically connect the ground circuit 150 to the second ground contact 264. The antenna element 250 is electrically connected to the wall 300 through the ground circuit 150, the ground contacts 262, 264 and the mounting screw 266. The grounding circuit 260 improves the operation of the antenna assembly 200, such as when mounted to a metal wall, particularly when mounted in the third mounting configuration, by reducing the non-radiative nearfield and increase the effective radiation efficiency.

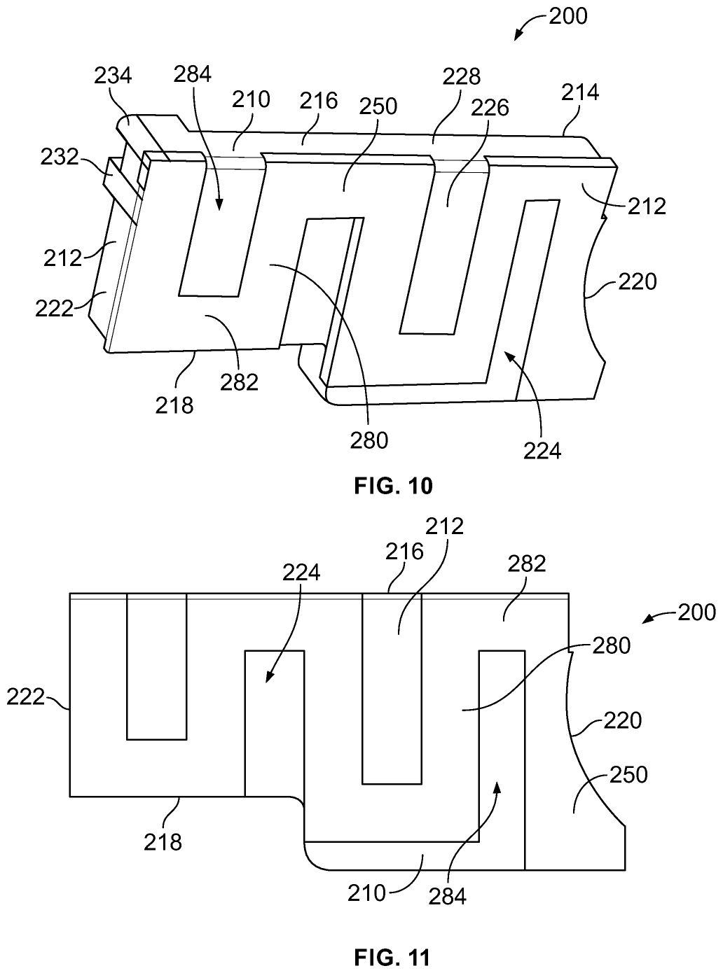

FIG. 10 is a perspective view of the antenna assembly 200 in accordance with an exemplary embodiment. FIG. 11 is an end view of the antenna assembly 200 in accordance with an exemplary embodiment. The antenna assembly 200 includes the substrate 210 and the antenna element 250 on the substrate 210.

The substrate 210 includes the front 212 and the rear 214 extending between the ends 220, 222 and the sides 216, 218. The substrate 210 may be generally box-shaped having generally orthogonal walls defining the exterior surface 224 of the substrate 210. The antenna element 250 is formed on the exterior surface 224, such as along the outer wall 226 and/or the sidewalls 228. The antenna element 250 may be formed on the interior. The antenna element 250 may be formed on the extension 230. The antenna element 250 may be formed on the first support leg 232 and/or the second support leg 234.

In an exemplary embodiment, the antenna element 250 is formed on the substrate 210. The antenna element 250 may be manufactured by laser direct structuring (LDS) the antenna element 250 on the substrate 210. The antenna element 250 may be a meandering or serpentine circuit element on the substrate 210. For example, the antenna element 250 may be a meandering planar inverted-F antenna (PIFA). The length of the meandering structure may correspond to ¼ wavelength of the operating frequency of the wireless device. The antenna element 250 is a radiating structure having a plurality of sections, such as forming a meandering radiating structure. The antenna element includes first portions 280 and second portions 282 between the first portions 280. The first portions 280 may be oriented parallel to each other. The second portions 282 may be orientated perpendicular to the first portions 280. Slots 284 are defined between the first and second portions 280, 282. The first portions 280 may extend on the outer wall 226 between the sides 216, 218. The first portions 280 may extend along the side walls 228. The second portions 282 may be located at corresponding sides 216, 218, such as along alternating sides 216, 218. The slots 284 may be open at corresponding sides 216, 218, such as along alternating sides 216 218. In the illustrated embodiment, five first portions 280 are provided with four second portions 282 and corresponding slots 284 between the first portions 280. The antenna element 250 may have other shapes in alternative embodiments.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical device comprising:
a device housing having an internal cavity, the device housing having a front and a rear opposite the front, the device housing having a first side and a second side extending between the front and the rear;
a device sensor in the internal cavity;
a control circuit board in the internal cavity, the control circuit board including a sensor circuit coupled to the device sensor, the control circuit board including a ground circuit, the control circuit board including a communication circuit having a feed circuit; and
an antenna assembly coupled to the control circuit board, the antenna assembly including a substrate mounted to the control circuit board and an antenna element extending along at least one surface of the substrate, the antenna element coupled to the feed circuit and the ground circuit, the antenna assembly including a switchable matching circuit coupled to the antenna element, the switchable matching circuit changing a feed impedance of the feed circuit.

2. The electrical device of claim 1, wherein the switchable matching circuit is operated in a first state when the device housing is mounted to a metal wall and the switchable matching circuit is operated in a second state when the device housing is mounted to a non-metal wall.

3. The electrical device of claim 1, wherein the switchable matching circuit has a first feed impedance when operated in a first state and the switchable matching circuit has a second feed impedance when operated in a second state.

4. The electrical device of claim 1, wherein the switchable matching circuit includes a first lump element and a second lump element having different capacitance values configured to be switchably coupled to the antenna element to change the feed impedance to the antenna element.

5. The electrical device of claim 1, wherein the switchable matching circuit is part of the control circuit board and operably coupled to the feed circuit.

6. The electrical device of claim 1, wherein the switchable matching circuit is automatically switched based on measured efficiency of operation of the antenna assembly.

7. The electrical device of claim 1, further comprising a mechanical switch coupled to the device housing and operably coupled to switchable matching circuit, the state of the switchable matching circuit being changed based on movement of the mechanical switch.

8. The electrical device of claim 1, wherein antenna element is communicatively coupled to a remote control unit, the antenna element configured to receive a control signal from the remote control unit, the switchable matching circuit being operated based on the control signal.

9. The electrical device of claim 1, wherein the device housing includes an external surface configured to be mounted to a mounting surface of a wall, a ground contact is coupled to the device housing and configured to be electrically connected to the wall, wherein the antenna element is electrically connected to the wall through the ground contact and the ground circuit of the control circuit board.

10. The electrical device of claim 9, further comprising a mounting screw coupled to the device housing and configured to be threadably coupled to the wall at the mounting surface, the screw being electrically conductive and configured to electrically connect the ground contact to the wall.

11. The electrical device of claim 1, wherein the antenna element includes a feed point and a feed contact coupled to the feed point, the feed contact having a spring finger being spring biased against the feed circuit to electrically connect the antenna element to the feed circuit.

12. The electrical device of claim 1, wherein the antenna element is a meandering PIFA antenna.

13. The electrical device of claim 1, wherein the first side of the device housing is configured to be mounted to a mounting surface of a wall, the antenna element being more closely positioned relative to the second wall than the first wall.

14. The electrical device of claim 1, wherein the substrate is spaced apart from the control circuit board toward the front of the device housing.

15. An antenna assembly for an electrical device comprising:
a control circuit board having a feed circuit and a ground circuit;
a substrate mounted to the control circuit board, the substrate having a surface;
an antenna element extending along the surface, the antenna element coupled to the feed circuit and the ground circuit; and
a switchable matching circuit coupled to the antenna element, the switchable matching circuit changing a feed impedance of the feed circuit.

16. The antenna assembly of claim 15, wherein the switchable matching circuit is operated in a first state when the antenna element is in close proximity to a metal wall and the switchable matching circuit is operated in a second state when the antenna element is not in close proximity to a metal wall.

17. The antenna assembly of claim 15, wherein the switchable matching circuit has a first feed impedance when operated in a first state and the switchable matching circuit has a second feed impedance when operated in a second state.

18. The antenna assembly of claim 15, further comprising a ground contact configured to be electrically connected to a metal wall, the antenna element being electrically connected to the wall through the ground contact and the ground circuit of the control circuit board.

19. An electrical device comprising:
a device housing having an internal cavity, the device housing having a front and a rear opposite the front, the device housing having a first side and a second side extending between the front and the rear, the device housing having an external surface configured to be mounted to a mounting surface of a wall;
a device sensor in the internal cavity;
a ground contact coupled to the device housing, the ground contact configured to be electrically connected to the wall;
a control circuit board in the internal cavity, the control circuit board including a sensor circuit coupled to the device sensor, the control circuit board including a communication circuit having a feed circuit, the control circuit board including a ground circuit, the ground circuit being electrically connected to the ground contact; and
an antenna assembly coupled to the control circuit board, the antenna assembly including a substrate mounted to the control circuit board and an antenna element extending along at least one surface of the substrate, the antenna element coupled to the feed circuit and the ground circuit, the antenna element being electrically connected to the wall through the ground contact and the ground circuit of the control circuit board.

20. The electrical device of claim 19, further comprising a mounting screw coupled to the device housing and configured to be threadably coupled to the wall at the mounting surface, the screw being electrically conductive and configured to electrically connect the ground contact to the wall.

21. The electrical device of claim 19, wherein the antenna assembly includes a switchable matching circuit coupled to the antenna element, the switchable matching circuit changing a feed impedance of the feed circuit.
